(19) United States
(12) Patent Application Publication
(10) Pub. No.: US 2016/0057783 A1
(43) Pub. Date: Feb. 25, 2016

(54) Mechanism for Providing Communication Resources for Random Access of a User

(71) Applicant: NOKIA SOLUTIONS AND NETWORKS OY, Espoo (FI)

(72) Inventors: Claudio ROSA, Randers (DK); Frank FREDERIKSEN, Klarup (DK); Klaus Ingemann PEDERSEN, Aalborg (DK); Per Henrik MICHAELSEN, Aalborg (DE)

(73) Assignee: Nokia Solutions and Networks Oy, Espoo (FI)

(21) Appl. No.: 14/780,060

(22) PCT Filed: Mar. 26, 2013
(86) PCT No.: PCT/EP2013/056340

§ 371 Date: Sep. 25, 2015

(51) Int. Cl. H04W 74/08; H04W 72/04; H04W 4/06

(52) U.S. Cl. CPC H04W 74/0833; H04W 4/06; H04W 72/0413

(57) ABSTRACT

In an LTE-A mobile communications system, provision of additional random access resources, called “shadow” PRACH, that are available to User Equipments, UEs, for a contention-free access procedure during handover. eNBs provide information on PRACH resources, broadcasting a first set of resources available for contention-based and contention-free random access and indicating via the X2 interface to neighbouring eNBs such additional PRACH resources, together with corresponding preambles, which are in turn indicated via dedicated signalling to UEs during a handover procedure.

### BACKGROUND

### Field

The present invention relates to a apparatuses, methods, systems, computer programs, computer program products and computer-readable media usable for controlling a communication of a communication element or terminal or user device with a communication network, for example with regard to a provision of resources for a random access procedure of the communication element etc.

The following description of background art may include insights, discoveries, understandings or disclosures, or associations, together with disclosures not known to the relevant art prior, to at least some examples of embodiments of the present invention but provided by the invention. Some such contributions of the invention may be specifically pointed out below, whereas other such contributions of the invention will be apparent from their context.

Some related art can e.g. be found in technical specifications according to 3GPP TS 36.300 (e.g. version 11.4.0).

The following meanings for the abbreviations used in this specification apply:
BS: base station
CPU: central processing unit
C-RNTI: cell radio network temporary identifier
eNB: evolved node B
ID: identification, identifier
HO: handover
LTE: Long Term Evolution
LTE-A: LTE Advanced
PRACH: physical random access channel
RACH: random access channel
RAN: radio access network
RF: radio frequency
RRC: radio resource control
SIB: system information block
SPRACH: shadow PRACH
TA: time advance
TTI: transmission timing interval
UE: user equipment
UL: uplink

In the last years, an increasing extension of communication networks, e.g. of wire based communication networks, such as the Integrated Services Digital Network (ISDN), DSL, or wireless communication networks, such as the cdma2000 (code division multiple access) system, cellular 3rd generation (3G) and fourth generation (4G) communication networks like the Universal Mobile Telecommunications System (UMTS), enhanced communication networks based e.g. on LTE or LTE-A, cellular 2nd generation (2G) communication networks like the Global System for Mobile communications (GSM), the General Packet Radio System (GPRS), the Enhanced Data Rates for Global Evolution (EDGE), or other wireless communication system, such as the Wireless Local Area Network (WLAN), Bluetooth or Worldwide Interoperability for Microwave Access (WiMAX), took place all over the world. Various organizations, such as the 3rd Generation Partnership Project (3GPP), Telecoms & Internet converged Services & Protocols for Advanced Networks (TISPAN), the International Telecommunication Union (ITU), 3rd Generation Partnership Project 2 (3GPP2), Internet Engineering Task Force (IETF), the IEEE (Institute of Electrical and Electronics Engineers), the WiMAX Forum and the like are working on standards for telecommunication network and access environments.

Generally, for properly establishing and handling a communication connection between terminal devices such as a user device or user equipment (UE) and another communication network element or user device, a database, a server, a host etc., one or more intermediate network elements such as communication network control elements, such as base stations, control nodes, support nodes or service nodes are involved which may belong to different communication network.

Basically, a communication network is typically divided into several cells controlled by a communication network control element like a BS or eNB. For accessing a cell, a communication element or user device conducts, for example, an access procedure with the communication network control element of the respective cell, e.g. with a corresponding eNB. Such an access procedure is for example a random access procedure.

In addition, when the communication element or user device is moving in the network, e.g. in an RRC Connected mode (the user device is in RRC_CONNECTED mode), it enters at some time the coverage area of another cell. In this case, it is necessary to provide a suitable handover functionality to maintain connectivity and services for the user device, so that the user device will be able to maintain continuous connectivity.

However, as different cells may usually have different coverage areas, and one user device may move from one cell to another, the handover mechanisms may also be used to address this.

For example, besides a classical network environment where plural cells of the same type (e.g. plural macro cells) are arranged in a neighboring manner, new approaches are provided in order to enhance the performance of communication networks. One of these approaches is the implementation of a heterogeneous network structure. A heterogeneous network may comprise e.g. a “normal” communication cell (i.e. a macro cell) controlled by a communication network control element, such as an eNB in LTE networks, and plural small cells having also an own communication network control element, which are referred to, for example, as local area or small cells controlled by a corresponding eNB or the like for a small cell. The term “small cell” is typically used to describe a low-powered radio access node or cell having a range of tens or some hundred meters. Small cells are typically designed to be used to offload mobile data traffic as a more efficient usage of radio spectrum. A heterogeneous network provides, for example, an improved coverage and the possibility for offloading from a communication in the macro cell to a small cell. The small cells are coupled, for example, to the communication network control element of the macro call by a backhaul network offering high capacity, or the like.

However, conventional handover mechanisms are based on a certain sequence of steps for coordinating resources between a source cell (from where the user device comes) and a target cell (to which the user device is to be moved), which require a certain amount of time. While such a sequence is acceptable in terms of time consumption for a classical environment, in case of a heterogeneous network structure, the required time can be seen as being too long. Furthermore, generally, a reduction of the time period required for a handover is always preferred.

### SUMMARY OF THE INVENTION

According to an example of an embodiment, there is provided, for example, an apparatus comprising at least one processor, and at least one memory for storing instructions to be executed by the processor, wherein the at least one memory and the instructions are configured to, with the at least one processor, cause the apparatus at least: to conduct a configuration of a first set of uplink communication resources for a random access procedure, and to conduct a configuration of a second set of uplink communication resources for a random access procedure, wherein the second set of uplink communication resources is different to the first set of uplink communication resources, to cause a transmission of information indicating communication resources of the first set of uplink communication resources by using a broadcasting signaling in a communication cell, and to cause a transmission of information indicating communication resources of the second set of uplink communication resources by using a dedicated signaling towards at least one dedicated recipient, the dedicated signaling being different to the broadcasting signaling.

In addition, according to an example of an embodiment, there is provided, for example, a method comprising conducting a configuration of a first set of uplink communication resources for a random access procedure, conducting a configuration of a second set of uplink communication resources for a random access procedure, wherein the second set of uplink communication resources is different to the first set of uplink communication resources, causing a transmission of information indicating communication resources of the first set of uplink communication resources by using a broadcasting signaling in a communication cell, and causing a transmission of information indicating communication resources of the second set of uplink communication resources by using a dedicated signaling towards at least one dedicated recipient, the dedicated signaling being different to the broadcasting signaling.

Moreover, according to an example of an embodiment, there is provided, for example, an apparatus comprising at least one processor, and at least one memory for storing instructions to be executed by the processor, wherein the at least one memory and the instructions are configured to, with the at least one processor, cause the apparatus at least: to conduct an operation requiring a contention free access procedure to a cell to which a connection is established, to receive, via a dedicated signaling, and process information indicating uplink communication resources of a second set of uplink communication resources for a random access procedure, the dedicated signaling being different to the broadcasting signaling, and to cause a random access procedure to the cell by using the uplink communication resources indicated in the received information.

In addition, according to an example of an embodiment, there is provided, for example, a method comprising conducting an operation requiring a contention free access procedure to a cell to which a connection is established, and receiving, via a dedicated signaling, information indicating uplink communication resources of a second set of uplink communication resources for a random access procedure, the dedicated signaling being different to the broadcasting signaling, processing the received information, and causing a random access procedure to the cell by using the uplink communication resources indicated in the received information.

In addition, according to examples of the proposed solution, there is provided, for example, a computer program product for a computer, comprising software code portions for performing the steps of the above defined methods, when said product is run on the computer. The computer program product may comprise a computer-readable medium on which said software code portions are stored. Furthermore, the computer program product may be directly loadable into the internal memory of the computer and/or transmittable via a network by means of at least one of upload, download and push procedures.

### BRIEF DESCRIPTION OF THE DRAWINGS

Some embodiments of the present invention are described below, by way of example only, with reference to the accompanying drawings, in which:

FIG. 1 shows a diagram illustrating a communication network configuration where some examples of embodiments are implemented;

FIG. 2 shows a diagram illustrating a configuration of a resource allocation for random access channels according to some examples of embodiments;

FIG. 3 shows a diagram illustrating a provisioning of pools of communication resources according to some examples of embodiments;

FIG. 4 shows a signaling diagram illustrating a handover procedure according to some examples of embodiments;

FIG. 5 shows a flow chart of a processing conducted in a communication network control element with regard to a resource provision and communication control procedure according to some examples of embodiments;

FIG. 6 shows a flow chart of a processing conducted in a communication element with regard to a resource provision and communication procedure according to some examples of embodiments;

FIG. 7 shows a diagram of a communication network control element including processing portions conducting functions according to some examples of embodiments; and

FIG. 8 shows a block circuit diagram of a communication element including processing portions conducting functions according to some examples of embodiments.

### DESCRIPTION OF PREFERRED EMBODIMENTS

In the following, some examples and embodiments are described with reference to the drawings. In the following, different exemplifying embodiments will be described using, as an example of a communication network, an LTE-Advanced based system. However, it is to be noted that the present invention is not limited to an application using such types of communication system, but is also applicable in other types of communication systems and the like.

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may also contain also features, structures, units, modules etc. that have not been specifically mentioned.

A basic system architecture of a communication network where examples of embodiments are applicable may comprise a commonly known architecture of one or more communication systems comprising a wired or wireless access network subsystem and a core network. Such an architecture may comprise one or more access network control elements, radio access network elements, access service network gateways or base transceiver stations, such as a base station or an eNB, which control a coverage area or cell (macro cell, small cell) and with which one or more communication elements or terminal devices such as a UE or another device having a similar function, such as a modem chipset, a chip, a module etc., which can also be part of a UE or attached as a separate element to a UE, or the like, are capable to communicate via one or more channels for transmitting several types of data. Furthermore, core network elements such as gateway network elements, policy and charging control network elements, mobility management entities and the like may be comprised.

The general functions and interconnections of the described elements, which also depend on the actual network type, are known to those skilled in the art and described in corresponding specifications, so that a detailed description thereof is omitted herein. However, it is to be noted that several additional network elements and signaling links may be employed for a communication to or from a communication element or terminal device like a UE and a communication network besides those described in detail herein below.

The communication network is also able to communicate with other networks, such as a public switched telephone network or the Internet. The communication network may also be able to support the usage of cloud services. It should be appreciated that eNBs or their functionalities may be implemented by using any node, host, server or access point etc. entity suitable for such a usage.

Furthermore, the described network elements, such as terminal devices or user devices like UEs, communication network control elements of a cell, like an eNB and the like, as well as corresponding functions as described herein may be implemented by software, e.g. by a computer program product for a computer, and/or by hardware. In any case, for executing their respective functions, correspondingly used devices, nodes or network elements may comprise several means, modules, units, components, etc. (not shown) which are required for control, processing and communication/signaling functionality. Such means, modules, units, components, etc. may comprise, for example, one or more processors or processor units including one or more processing portions for executing instructions and/or programs and/or for processing data, storage or memory means or means for storing instructions, programs and/or data, for serving as a work area of the processor or processing portion and the like (e.g. ROM, RAM, EEPROM, and the like), input means for inputting data and instructions by software (e.g. floppy disc, CD-ROM, EEPROM, and the like), a user interface for providing monitor and manipulation possibilities to a user (e.g. a screen, a keyboard and the like), other interfaces or means for establishing links and/or connections under the control of the processor unit or portion (e.g. wired and wireless interface means, radio interface means comprising e.g. an antenna unit or the like, means for forming a radio communication part etc.) and the like, wherein respective means forming an interface, such as a radio communication part, can be also located on a remote site (e.g. a radio head or radio station, etc.). It is to be noted that in the present specification processing portions should not be only considered to represent physical portions of one or more processors, but may also be considered as a logical division of the referred processing tasks performed by one or more processors.

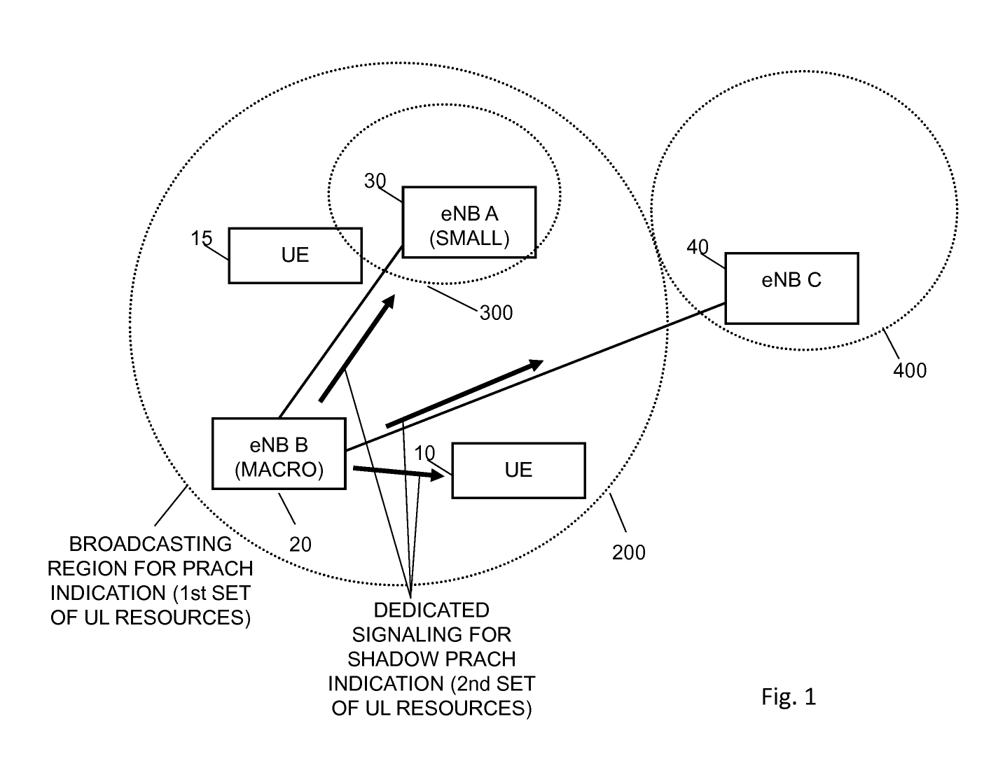

With regard to FIG. 1, a diagram illustrating a general configuration of a communication network where some examples of embodiments of the invention are implemented is shown. It is to be noted that the configuration shown in FIG. 1 shows only those devices, network elements and/or parts which are useful for understanding principles underlying the examples of embodiments. As also known by those skilled in the art there may be several other network elements or devices involved in a communication between the communication element like the user device (UE) and the network which are omitted here for the sake of simplicity.

In FIG. 1, a communication network configuration is illustrated in which some examples of embodiments are implementable. The network according to FIG. 1 is for example based on the 3GPP specifications and comprises elements of a heterogeneous network including a primary serving cell (macro cell) and one or more secondary cells (small cells), and elements of parallel (neighboring) macro cells. It is to be noted that the general functions of the elements described in connection with FIG. 1 as well as of reference points/interfaces between the elements are known to those skilled in the art so that a detailed description thereof is omitted here for the sake of simplicity.

As shown in FIG. 1, in the exemplary communication network, a communication element like a user device (such as UE) 10 is located in a macro cell 200 controlled by a (macro) eNB B 20 as a communication network control element. Additionally, a UE 15 is located in a small cell 300 controlled by a (small) eNB A 30 as a communication network control element. The cells 200 and 300 are hereinafter referred to as neighboring cells as their coverage areas are (at least partly) overlapping, allowing an execution of a handover procedure therebetween.

As also depicted in FIG. 1, the communication network comprises a further element formed by a neighboring cell 400 controlled by an eNB C 40 as a communication network control element. Here, the cells 200 and 400 are assumed to be neighboring cells.

It is to be noted that the term “neighboring cell” is to be understand in such a manner that the respective cells have at least partly overlapping coverage areas for their radio connections towards a communication element so that it is possible that the radio connection of a communication element is moved (if possible without interruption) from one cell to the other cell of the neighboring cells. In other words, neighboring cells are those cells which represent candidates for a handover to and from each other, wherein of course more than two cells can be neighboring cells to each other, depending on the current network architecture etc.

The communication element or terminal devices UE 10 and UE 15 are configured to communicate with the communication network via at least one of the eNB B 20, eNB A 30 or eNB C 40 by using, for example, an air interface.

The communication network control elements eNB A 30, eNB B20 and eNB C 40 are connected by suitable interfaces and a backhaul network, for example by means of so-called X2 interfaces which are used to exchange messages and information between the communication network control elements and to enable the nodes to directly communicate with each other.

It should be appreciated that according to some examples, a so-called “liquid” or flexible radio concept is employed where the operations and functionalities of a communication network control element or of another entity of the communication network, such as of one or more of the shown eNBs, may be performed in different entities, such as a node, host or server, in a flexible manner. In other words, a “division of labour” between involved network elements or entities may vary case by case. One possible alternative to the example illustrated is, for example, is to make a base station or the like to deliver local content.

It is to be noted that even though FIG. 1 shows three cells 200, 300, 400, the number of cells is not limited thereto and can be more or less than three, wherein at least two cells form neighboring cells.

In the example shown in FIG. 1, for illustrating examples of embodiments, it is now assumed that the UE 10 is coupled to the eNB B 20 wherein it is further assumed that the UE 10 has to conduct a communication operation requiring e.g. a contention-free access procedure, such as in case of a time advance update.

On the other hand, for illustrating further examples of embodiments, it is assumed that the UE 15 is originally coupled to e.g. the small cell (i.e. the eNB A 30 provides, for example, a connection to a core network (not shown in FIG. 1) of the communication network). Due to mobility reasons or connection quality changes, it is further assumed that the connection of the UE 15 is to be switched from cell 300 to another (neighboring) cell, which is cell 200. Consequently, a handover procedure is to be conducted for the UE 15 to switch the connection from eNB A 30 (representing the source eNB) to the eNB B 20 (representing the target eNB).

For procedures using examples of embodiments, the provision of communication resources usable for a random access procedure is executed. That is, for example, resources comprising a set of uplink physical resources defined through various parameters such as root sequence, periodicity and time-wise offset are provided which are reserved for a random access procedure towards a cell (e.g. eNB B 20) so as to conduct an access procedure, e.g. in case of a handover of a communication device or in case of a communication operation such as a time advance update procedure of an already connection communication element. In the LTE-based communication network shown in FIG. 1, corresponding resources are referred to as PRACH resources.

The signalling of PRACH resources is typically provided through signalling from the corresponding eNB allowing to conduct an access procedure. For example, signalling bearers carry corresponding information indicating the available PRACH resources, wherein a communication element being in the radio area of the eNB read this information. As means for transporting the information, system information block (e.g. SIB2) is used.

PRACH resources can be divided into two different sub-sets, i.e. one sub-set for a contention based access in which multiple UEs may potentially use the same resources for access requests, and one sub-set for a non-contention based or contention-free access in which a given communication element (UE) is provided with a specific or dedicated resource which is guaranteed to be collision free. The contention-free access allows a more reliable and hence faster access to a cell, and it is usable e.g. for a dedicated handover procedure or an update of time advance values by a connected UE.

Conventionally, according to a comparative example, dimensioning of the available system resources allocated for PRACH resources is done by using a time division fragmentation. That is, for example, one n^{th} of the subframes of the UL radio resources are defined to have resources available for PRACH. From a configuration point of view, it is possible to adjust the “phase” of this time division such that different cells have different PRACH allocations. However, in such a PRACH allocation scheme, the resources which are reserved for becoming PRACH resources are also to be divided between contention-based and non-contention based (contention-free) resources, which limits the number or amount of resources available for e.g. the contention-free resources, which in turn are required e.g. for a fast and easy handover between cells.

The only other granularity (rather than the PRACH preambles) that is feasible for distributing PRACH resources is the value of the subframe parameter, i.e. how often the PRACH exists in the UL resources.

According to some examples of embodiments, the number of available dedicated PRACH resources, i.e. of resources allowing a contention-free access, for example, is increased. For example, according to some examples of embodiments, a set of additional PRACH resources existing besides the normal PRACH resources is created by a communication network control element which is a potential target for a random access procedure requiring a contention-free access (in the example discussed in FIG. 1, e.g. eNB B 20, but also the other eNBs may have the potential to create such a set of additional PRACH). This additional set of PRACH resources is referred to hereinafter as “shadow” PRACH resources or SPRACH resources, wherein also other names like “additional RACH resources”, “additional PRACH resources”, “secondary RACH resources”, “secondary PRACH resources” can be used for it. According to some examples of embodiments, SPRACH resources (or the like) are pre-reserved in an orthogonal manner with regard to the normal PRACH resources.

According to some examples of embodiments, the “normal” PRACH resources (i.e. the resources reserved as PRACH resources as in a conventional case) are allocated and signaled in the own cell to respective communication elements in any manner, e.g. by using SIB2 signaling.

On the other hand, the additional SPRACH resources are not signaled by common signaling, such as broadcasting signaling or the like (i.e. in a manner that any recipient being able to communicate with the cell). That is, a communication element such as a UE (e.g. in a connected state or listening to the bearers of the cell) is generally not informed about the SPRACH resources, at least not via a conventionally signaling used for the provision of random access resource information, as there is no broadcast of this information on the common channels. Instead, as indicated in FIG. 1, a dedicated signaling of information indicating the SPRACH resources is executed. For example, the SPRACH resources can be signaled to one or more neighboring cells, e.g. by using an interconnection of the eNBs like an X2 interface, or by a dedicated signaling to at least one connected communication element, such as UE 10, that is to a dedicated receiving UE or to a dedicated group of receiving UEs.

That is, according to some examples of embodiments, the communication network control element creating/reserving the set of SPRACH resources is able to indicate these SPRACH resources to a potential neighboring cell, which is then able to use this indication of SPRACH resource, e.g. in connection with a provision of resources to UEs trying to access the target cell or eNB (i.e. eNB B 20). That is, by means of the SPRACH resources, a (potential target) eNB is able to create a larger set of resources that are dedicated for a contention-free access to it.

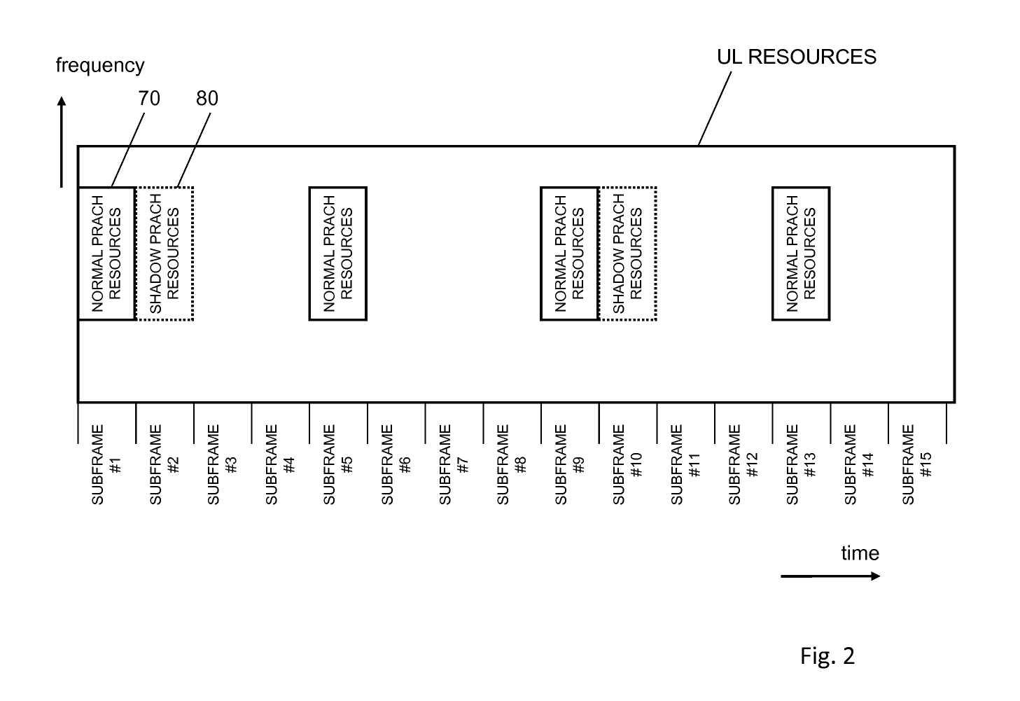

FIG. 2 shows a diagram illustrating a configuration of a resource allocation for random access channels according to some examples of embodiments of the invention.

In detail, FIG. 2 shows a diagram illustrating a structure of UL resources (frequency and time based) which is divided in several successive sub-frames (sub-frame#1 to sub-frame #15) in the time domain. Indicated by boxes in the respective subframes, resources allocated as PRACH resources are illustrated. Specifically, solid boxes as indicated by reference sign 70 define normal PRACH resources (i.e. whose indication is broadcasted by using SIB2), while dashed boxes as indicated by reference sign 80 define SPRACH resources (signaled by dedicated signaling, as shown by arrows in FIG. 1).

According to some examples of embodiments, the communication network control element such as eNB B 20 which configures the resources for becoming SPRACH resources introduces the orthogonality in the PRACH domain by introducing a segmentation of the resources in the time domain. That is, 1/n^{th} of the TTIs is used for normal PRACH access, wherein n is the ordinary recurrence of PRACH TTIs. Furthermore, the eNB B 20 create the second set of PRACH resources, i.e. the SPRACH resources, which occur every m^{th} TTI. It is to be noted that m is equal to or greater than n. Furthermore, the SPRACH resources 80 are set to occur with a different time offset or “phase” compared to the normal PRACH resources 70. Thus, the normal PRACH resources and the SPRACH resources are be orthogonal to each other, and collisions thereof can be avoided.

When referring to FIG. 2, the PRACH resource situation as seen by an eNB, there is a set of broadcasted resources (i.e. PRACH resources which are indicated by boadcasting signaling) defined by the solid boxes (e.g. box 70). According to some examples of embodiments, the information on the configuration of these resources is sent to the cell coverage area using e.g. a conventional broadcasting method which uses e.g. SIB2. In the illustrated example, every 4^{th} subframe is configured for (normal) PRACH transmission. It is to be noted that the normal PRACH resources can be divided into resources for contention-based access and resources for contention-free access, wherein the information related to the normal PRACH resources (e.g. SIB2) indicates which of these resources are reserved for contention-free access and which are reserved for contention based access.

On the other hand, the SPRACH resources (which are not indicated by boadcasting signaling but by dedicated signaling), which are defined by the dashed boxes (e.g. box 80), are configured by the eNB in other subframes. For example, as indicated in FIG. 2, SPRACH resources are configured to be present in every 8^{th} subframe, wherein a time offset of “1” compared to the normal allocation of PRACH resources (box 70) is considered.

It is to be noted that the values of periodicity and time-wise offset as described in connection with FIG. 2 are only exemplary in nature and can be different to the values indicated above. According to some examples of embodiments, one limitation for the selection of the values of periodicity and time-wise offset for the PRACH resources is that an overall allocation is not larger than “1”. This limitation is useful, for example, for avoiding of collision of the normal PRACH and SPRACH resources over the time.

Furthermore, it is to be noted that according to some examples of embodiments, the normal PRACH resources and the SPRACH resources are set in different subframes. On the other hand, according to some examples of embodiments, the normal PRACH and SPRACH resources are set in the same subframe, wherein a time offset within the subframe is provided.

By virtue of the proposed solutions, it is possible to an enhanced mechanism for controlling a communication of a communication element or terminal or user device with a communication network. That is, it is possible to provide an apparatus, a method and a computer program product which allow, for example, to provide additional resources for a random access procedure of a communication element, wherein the additional resources are usable for a contention-free access. At the same time, the load for the normal resources can be reduced. Furthermore, the additional resources are useful for enhancing a handover procedure of the communication element between different cells of a communication network, for example, in connection with a so-called fast handover procedure

As described above, the SPRACH resources are configured for obtaining additional resources for various purposes.

For example, according to some examples of embodiments, information indicating the SPRACH resources reserved by the (target) eNB is sent to one or more neighboring cells where a communication element is connected from which a handover could be initiated.

That is, for example, a handover procedure as described below is conducted between two cells (e.g. cell 300 to cell 200) for a UE (e.g. UE 15) wherein the SPRACH resources are used. It is to be noted that an actual handover procedure according to this example may comprise additional steps which are omitted here for the sake of simplicity.

In order to be able to decide whether a handover is required, the communication network control element requires for example connection quality related measurements conducted by itself and the UE. Consequently the UE 15 is configured to perform such measurements (radio resource management measurements or the like) and to send a measurement report when e.g. a certain trigger is present (for example, in case it is observed by the UE that certain conditions or parameters are above or below a given threshold (measurement conditions) and make a handover necessary.

That is, in a as shown in FIG. 1, the UE (UE 15) is triggered to conduct a transmission of a measurement report to the current serving eNB (e.g. eNB A 30 as the current base station that the UE 15 is connected to) which becomes thus the source eNB of the handover. For example, the measurement report contains information usable as an identification of a cell or eNB which is seen as a target eNB for the handover (i.e. the base station of which e.g. the communication quality is best and represents hence the preferred target for the UE 15, e.g. eNB B 20). The measurement report is transmitted by using e.g. RRC signaling from the UE to the source eNB.

When receiving the measurement report (which represents more or less a handover request), the source eNB (eNB A 30) decides whether to conduct a handover, and if the decision is affirmative, it sends a handover request to the target eNB (eNB B 20). This signaling is handled e.g. over the X2 interface between the eNBs.

The target eNB B 20 prepares for the handover and provides information to the source eNB with information regarding resources to be used by the UE 10 for the handover. These resources comprise, for example, a temporary identifier to be used by the UE 10 in the new cell, such as a C-RNTI, and a random access channel related preamble. According to examples of embodiments, the eNB B 20 selects one of the SPRACH resources and determines a corresponding PRACH preamble for the SPRACH being selected (also referred to as SPRACH preamble), which in turn is to be used by the UE 15 in the access procedure to the new cell (contention-free access due to dedicated access procedure). Again, this information is handled e.g. over the X2 interface between the eNBs.

The source eNB A 30 now sends a handover command to the UE 15, by means of which the UE 15 is instructed which resources are to be used when accessing the new target cell. This signaling is carried by using RRC signaling (e.g. by using an RRC_reconfiguration message).

The UE 15 attempts to access the target eNB with the given SPRACH preamble (a given physical resource), i.e. the handover procedure is continued by accessing the new cell.

When receiving the access request from the UE 15, the target eNB responds to the requesting UE for example with a message which is “signed” with the C-RNTI that was assigned to the UE 15 beforehand and transmitted via the X2 interface to the source eNB A 30. Furthermore, additional information is provided to the UE, such as different radio channel parameters to be used, like the time advance (TA) value to be used, a transmit power level, etc.

When the handover is completed (also by switching paths with regard to the core network), the target eNB B 20 (which becomes the new serving eNB for the UE 15) informs the old (source) eNB A 30 that the handover is completed.

It is to be noted that during the handover as described above the source eNB takes care that data directed to the UE is forwarded to the target eNB until the core network makes the switch of the traffic flow.

That is, the SPRACH resources are usable in a handover procedure as an additional set of resources provided in response to a request from a neighboring cell for a PRACH resource for handover.

In the following, a further example of embodiments is described where information indicating the SPRACH resources reserved by the (target) eNB is sent to one or more neighboring cells where a communication element is connected from which a handover could be initiated.

According to these examples, a fast handover operation is conducted using the SPRACH resources.

According to these examples of embodiments, neighbor nodes or cells are provided with pre-configuration of PRACH resources which comprises also SPRACH resources. That is, PRACH resources (and also the SPRACH resources) are coupled to a specific C-RNTI so that the neighboring cell is able to executed a fast handover/hand off to the new cell (i.e. the eNB B 20, for example).

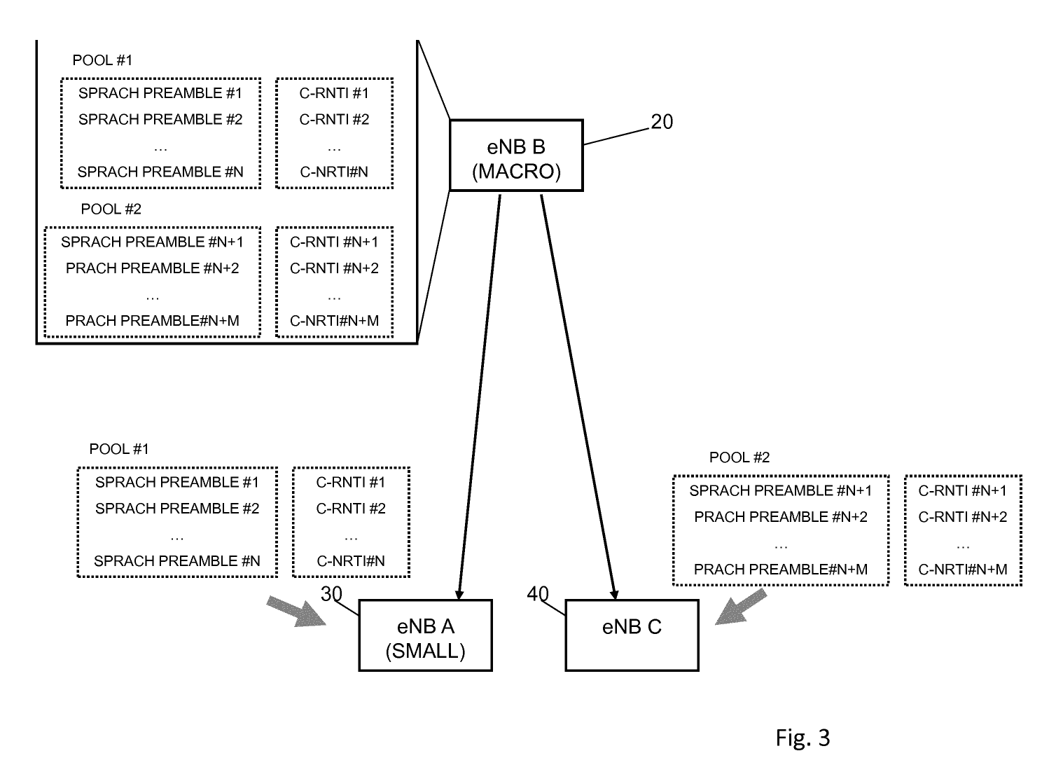

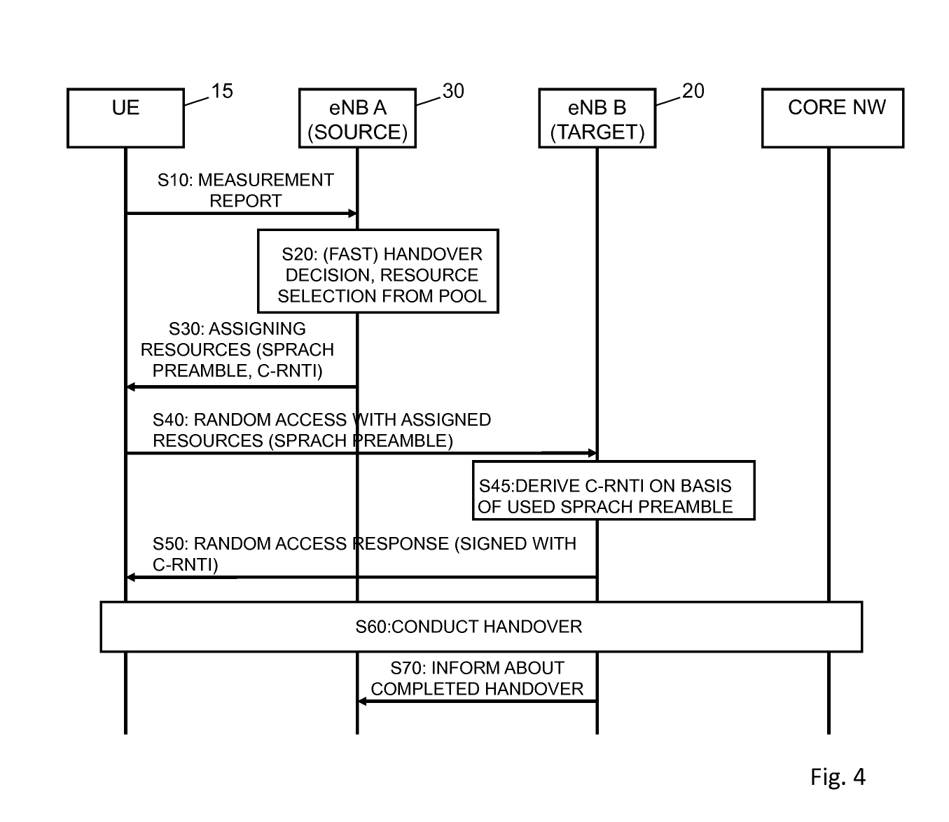

A corresponding procedure is described in connection with FIGS. 3 and 4. FIG. 3 shows a diagram illustrating a provisioning of pools of communication resources according to some examples of embodiments, and FIG. 4 shows a signaling diagram illustrating a handover procedure according to some examples of embodiments.

According to some examples of embodiments, as one part, a concept of creating a pool of communication resources for a fast handover (or for enabling a low-latency handover) is provided which comprises SPRACH resources. This pool of communication resources may be maintained at the source eNB and may be coupled/allocated to specific target eNBs. In addition, as a second part, according to some examples of embodiments, mechanisms are provided allowing to facilitate maintenance of such a pool of communication resources, e.g. by signaling over an established interface (X2 or similar) between the eNBs.

For example, according to some examples of embodiments, the resources or sets of communication resources forming a pool of communication resources may comprise at least SPRACH resources (SPRACH preambles) and associated C-RNTI resources.

With regard to the resource pool functionality indicated above, as shown in FIG. 3, for preparing a fast handover procedure according to some examples of embodiments, neighboring cells, i.e. communication network control elements such as eNBs (e.g. eNB A 30 and eNB B 20, or eNB C 40 and eNB B 20 in FIG. 1) exchange information related to resources that are allowed to be used for a fast handover in connection with a pre-reserved pool of communication resources for a fast handover which comprises SPRACH resources being configured beforehand, as described above. In the illustrated example, for the sake of simplicity, a case is described where respective two eNBs exchange the information, wherein one of the eNBs is assumed to act as a target eNB (i.e. the eNB to which the UE is to be handed over, which therefore has to provide the resource information), and the other of the eNBs is assumed to act as the source eNB (i.e. the eNB from which the UE is to be handed over, which therefore has to store the resource information). However, examples of embodiments are not limited to such a scenario. For example, more than one pool of communication resources can be provided and stored.

As the described example is related to eNBs as communication network control elements, the signaling related to the information exchange takes place over corresponding X2 interfaces, but it is obvious that according to further examples of embodiments of the invention, when other communication network control elements than eNBs are concerned, similar interfaces different to the X2 interface can be used, dependent on predefined network setup parameters.

Referring now to the example of FIG. 3, the eNB B 20 creates plural pools of communication resources (pool #1, pool #2), each of which is provided with plural sets of communication resources, wherein each set of communication resource comprises at least an SPRACH preamble (#1 to #N for pool #1; #N+1 to #N+M for pool #2) and a C-RNTI (#1 to #N for pool #1; #N+1 for pool #2). It is to be noted that the pools can comprise also normal PRACH resources (as indicated in pool #2 for #N+2 to #N+M).

For example, according to some examples of embodiments, the neighboring eNBs of eNB B 20, i.e. eNB A 30 and eNB C 40, request from the eNB B 20 an allocation of one or more sets of communication resources, i.e. PRACH preambles and associated C-RNTIs, which are reserved for fast handover from eNB A 30 (or eNB C 40) to eNB B 20.

The eNB B 20 may check the requests and determines a specified number of sets of resources which can be reserved for a fast handover. For example, the eNB B 20 determines an amount of resources which is requested by the neighboring cells, and determines an amount of resources which are generally available. In this connection, besides the normal PRACH resources, the SPRACH resources are considered as well. Furthermore, according to examples of embodiments, it estimates a need for resources related to each requesting eNB, considers possible requests from other eNBs, and estimates the overall usage of PRACH to the eNB B 20. On the basis thereof, it may agree to the requested amount of resources or increases or decreases a number of resources allocated to the reserved resources. That is, the amount of resources reserved for fast handover may be determined by the eNB B 20 and may for instance be less that requested by the eNB A 30, e.g. in case there are not enough resources available.

Thus, respective pools of communication resources (pool #1 and pool #2) may be created by the eNB B 20, as shown in FIG. 3.

It is to be noted that the neighboring eNBs can repeat a request for allocating resources when, for example, a requirement for a higher or lower amount determined on the respective eNB side. However, also in this case the decision regarding the amount of resources to be allocated is on the eNB B 20 side.

Next, the requesting neighboring eNBs may be provided with a pool of communication resources. For example, as indicated in FIG. 3, the eNB A 30 is provided with pool #1, and the eNB C 40 is provided with pool #2. That is, e.g. on the eNB A 30, the sets of communication resources indicated in the pool #1 are allocated to be used for a handover to eNB B 20.

The provision of the pools (i.e. of information indicating the content of the respective pool) is executed via X2 interface, for example, as a response to a request from the respective eNB, or when a modification of the contents of the pool is to be conducted (for example, due to changes in an estimated usage or the like requiring a higher amount of resources).

It is to be noted that according to some examples of embodiments, when a modification of the contents of a pool requires to decrease the number of sets of communication resources, the corresponding eNB (e.g. eNB A 30) has to acknowledge the freeing of the resources. This implies that the freed resources are no more in use for fast handover from the eNB A 30 to the eNB B 20. According to some examples of embodiments, in case the acknowledgement is not provided, the modification is cancelled.

It is to be noted that according to some examples of embodiments, a modification procedure is also conducted by the eNB B 20 in case a handover from e.g. eNB A 30 to eNB B 20 is performed, where the UE uses one of the pre-assigned sets of communications resources (i.e. a SPRACH preamble and C-RNTI pair). In this case, according to some examples of embodiments, the eNB B 20 informs the source eNB (eNB A 30) after a successful handover to the eNB B 20, wherein also an update of the pool of communication resources (i.e. of the pre-assigned sets of communication resources (comprising SPRACH preamble and C-RNTI) that the eNB A 30 is afterwards allowed to use for UEs making a handover from the eNB A 30 to eNB B 20 is considered (i.e. the used set of communication resources is removed or replaced in the pool #1).

FIG. 4 shows a signaling diagram illustrating a handover procedure according to some examples of embodiments.

Assuming that, in accordance with a processing as described in connection with FIG. 3, the pools of communication resources are created and provided to the possible source eNBs (e.g. pool #1 to eNB A 30) which in turn have allocated the information to the possible target eNB (e.g. eNB B 20), i.e. the pre-assigned resources (SPRACH/PRACH preambles and associated C-RNTIs) for a fast handover of a UE between eNBs (i.e. eNB A 30 as source eNB and eNB B 20 as a target eNB), according to some examples of embodiments, a corresponding fast handover procedure is conducted as illustrated in FIG. 4.

As already described above in connection with the first examples related to a handover procedure, in order to be able to decide whether a handover is required, the communication network control element serving a UE requires for example connection quality related measurements conducted by itself and the UE.

Consequently, in S10, the UE 15 may perform such measurements and send a measurement report when e.g. a certain trigger is present (for example, in case it is observed by the UE 15 that certain conditions or parameters are above or below a given threshold (measurement conditions) and make a handover necessary for moving from the current cell (e.g. cell 300) to another cell.

That is, in the system according to FIG. 1, the UE 15 may be triggered to conduct a transmission of a measurement report to the current eNB A 30 as the current base station that the UE 15 is connected to. For example, the measurement report comprises information usable as an identification of a cell or eNB which is seen as a target eNB for the handover (i.e. the base station of which e.g. the communication quality is best and represents hence the preferred target for the UE 15, e.g. eNB B 20). The measurement report may be transmitted by using e.g. RRC signaling from the UE to the source eNB.

In S20, when receiving the measurement report (which represents more or less a handover request), the eNB A 30 may decide whether to conduct a handover.

When the handover decision is affirmative, according to some examples of embodiments, it is checked whether a pool of communication resources for a fast handover procedure is allocated at the eNB A 30 for the target eNB (here, eNB B 20). If this is the case, a set of communication resources is selected from the pool (e.g. pool #1 of FIG. 2) and assigned to the UE 10 (otherwise, in case no pool of communication resources is allocated, a normal handover procedure as described above may be conducted). That is, the source eNB assigns one set of communication resources (SPRACH preamble and associated C-RNTI) to the UE 15 via RRC signaling in step S30.

When receiving the information regarding the set of communication resources assigned to the UE 15, according to some examples of embodiments, the UE 15 starts the (fast) handover e.g. by random access in the new target cell (e.g. cell 200 and eNB B 20). For this purpose, the UE 15 attempts to access the target eNB B 20 by means of a random access with assigned resources, e.g. with the given SPRACH preamble, in S40. That is, the UE 15 continues the handover procedure by accessing the new cell.

When receiving the access request from the UE 15, the target eNB B 20 derives in S45, on the basis of the used SPRACH preamble, the associated C-RNTI. Consequently, the eNB B 20 responds in S50 to the random access request of the requesting UE 15, for example, with a message which is “signed” with the C-RNTI that was assigned to the UE 15 beforehand and transmitted via the X2 interface to the source eNB A 30. Furthermore, according to some examples of embodiments, in S50, additional information are provided to the UE 15, such as different radio channel parameters to be used, like the time advance (TA) value to be used, a transmit power level, etc.

Then, in S60, the handover to the new target cell (eNB B 20) is completed.

When the handover is completed (also by switching paths with regard to the core network), the target eNB B 20 (which becomes the new serving eNB for the UE) informs the old (source) eNB A 30 that the handover is completed. The source eNB takes care that data is forwarded to the target eNB until the core network makes the switch of the traffic flow.

Next, a further example of embodiments is described where the SPRACH resources configured for obtaining additional resources for various purposes are usable.

That is, in the following example, different to a handover case, information indicating the SPRACH resources reserved by the eNB is sent to at least one communication element or user device being connected to the eNB (i.e. connected to the own cell), that is to one dedicated UE or to a dedicated group of UEs, for example.

For example, the communication element (e.g. UE 10 shown in FIG. 1) intends to make a contention-free access to the own cell. This operation is conducted, for example, when a time advance timer is expired and a time advance update is necessary.

That is, according to the present example, since a random access for a dedicated purpose is detected, wherein a UE requires a contention-free access, the eNB B 20 to which the UE 10 is connected informs the UE 10 about SPRACH resources allowing a contention-free access. Since the SPRACH resources are not broadcasted, the UE 10 obtains the information by means of dedicated signaling. That is, the information about the SPRACH resources are not derived from SIB2, for example, but from a dedicated signaling between the UE 10 and the eNB B 20.

Consequently, the load on the “normal” PRACH resources which are continued to be broadcasted can be reduced.

Furthermore, according to additional examples of embodiments of the invention, the UE 10 sends a request message to the eNB B 20 so as to trigger the provision of information regarding contention-free random access resources which is answered by the eNB B 20 by using SPRACH resources.

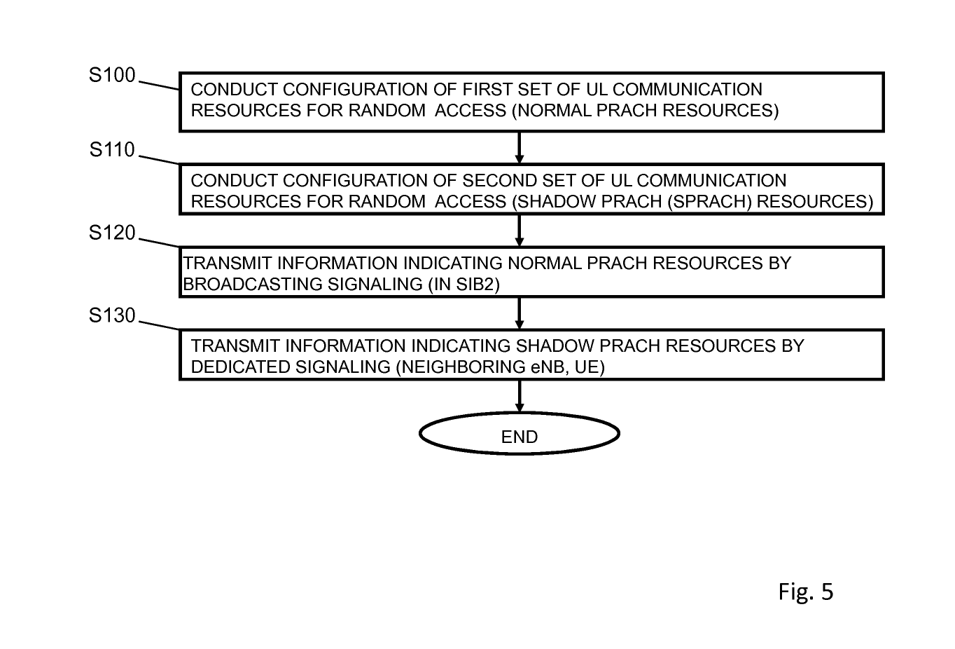

FIG. 5 shows a flowchart illustrating a processing executable in a communication network control element, like the eNB B 20 of FIG. 1, according to some examples of embodiments.

In S100, a configuration of a first set of UL communication resources for a random access procedure is conducted (i.e. the normal PRACH resources shown in FIG. 2, for example).

In S110, a configuration of a second set of UL communication resources for a random access procedure is conducted (i.e. the SPRACH resources shown in FIG. 2, for example). The second set of UL communication resources is different to the first set of UL communication resources.

For example, according to some examples of embodiments, the configuration of the first set of UL communication resources for the random access procedure is done by reserving UL communication resources with a first periodicity, and the configuration of the second set of UL communication resources for the random access procedure is done by reserving UL communication resources with a second periodicity, wherein the second periodicity is equal to or greater than the first periodicity. Alternatively or additionally, according to some examples of embodiments, the configuration of the first set of UL communication resources for the random access procedure is done by reserving UL communication resources in a first subframe, and the configuration of the second set of UL communication resources for the random access procedure is done by reserving UL communication resources in a second subframe, wherein the second subframe is provided with a predetermined time offset compared to the first subframe. Moreover, alternatively or additionally, according to some examples of embodiments, the configuration of the first set of UL communication resources for the random access procedure is done by reserving UL communication resources, wherein the UL communication resources reserved for the first set of uplink communication resources are divided in a first subset allocated to a contention-free access procedure and a second subset allocated to a contention-based access procedure, and the configuration of the second set of UL communication resources for the random access procedure is done by reserving UL communication resources, wherein the UL communication resources reserved for the second set of UL communication resources are allocated to a contention-free access procedure.

In S120, a transmission of information indicating communication resources of the first set of UL communication resources is caused by using a broadcasting signaling in a communication cell. For example, according to some examples of embodiments, the transmission of information indicating communication resources of the first set of UL communication resources is done by using a system information block (e.g. SIB2) broadcasted in the communication cell.

In S130, a transmission of information indicating communication resources of the second set of UL communication resources is caused by using a dedicated signaling towards at least one dedicated recipient. The dedicated signaling is different to the broadcasting signaling. For example, according to some examples of embodiments, the transmission of information indicating communication resources of the second set of UL communication resources is done by using a dedicated signaling towards at least one communication network control element of a neighboring cell with regard to a handover procedure for a communication element from the neighboring cell.

According to some examples of embodiments, the transmission of information indicating communication resources of the second set of UL communication resources is done by using a dedicated signaling towards the at least one communication network control element of the neighboring cell in reaction to a handover request for a communication element (UE 15) from the neighboring cell, wherein the handover request is received from the neighboring cell and indicates the requirement to provide information regarding UL communication resources to be used for an access request by the communication element.

Alternatively or additionally, according to some examples of embodiments, the transmission of information indicating communication resources of the second set of uplink communication resources is done by using a dedicated signaling towards the at least one communication network control element of the neighboring cell in connection with a transmission of information indicating, to the neighboring cell, a content of a pool of communication resources for a fast handover procedure, wherein at least one communication resource of the second set of UL communication resources is allocated to the pool of communication resources.

Alternatively or additionally, according to some examples of embodiments, the transmission of information indicating communication resources of the second set of UL communication resources is done by using a dedicated signaling towards at least one communication element (UE 10) of the own cell with regard to an operation requiring a contention-free access procedure of the communication element.

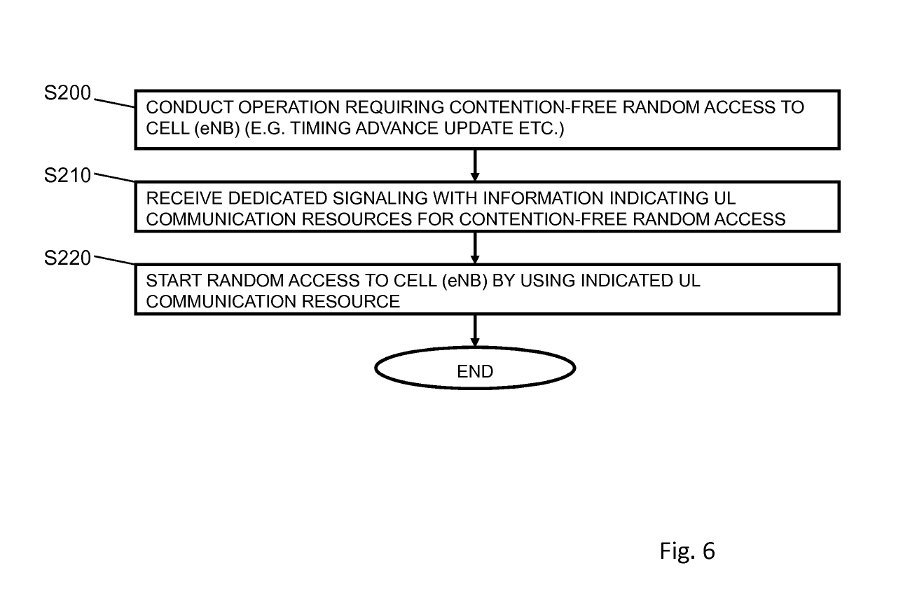

FIG. 6 shows a flowchart illustrating a processing executable in a communication element, like the UE 10 of FIG. 1, according to some examples of embodiments.

In S200, an operation requiring a contention free access procedure to a cell to which a connection is established is executed. For example, according to some examples of embodiments, the operation is a timing advance update procedure. Furthermore, according to some examples of embodiments, the processing comprises to request provisioning of information indicating UL communication resources usable for a contention-free access procedure.

In S210, information indicating UL communication resources of a second set of UL communication resources (SPRACH resources) for a random access procedure is received via a dedicated signaling, wherein the dedicated signaling is different to a broadcasting signaling. For example, according to some examples of embodiments, the information is received in reaction to a request for provisioning information indicating UL communication resources usable for a contention-free access procedure.

It is to be noted that in addition to the information received via the dedicated signaling, according to some examples of embodiments, information indicating UL communication resources of a first set of uplink communication resources for a random access procedure is received via a broadcasting signaling. For example, the information indicating UL communication resources of the first set of uplink communication resources is received in the form of a system information block (e.g. SIB2) broadcasted in the communication cell.

According to some examples of embodiments, the UL communication resources of the first set of UL communication resources have a first periodicity and the UL communication resources of the second set of UL communication resources have a second periodicity, wherein the second periodicity is equal to or greater than the first periodicity. Alternatively or additionally, according to some examples of embodiments, the UL communication resources of the first set of UL communication resources are located in a first subframe and the UL communication resources of the second set of UL communication resources are located in a second subframe, wherein the second subframe is provided with a predetermined time offset compared to the first subframe. Alternatively or additionally, according to some examples of embodiments, the UL communication resources of the first set of UL communication resources are divided in a first subset allocated to a contention-free access procedure and a second subset allocated to a contention-based access procedure, and the UL communication resources of the second set of UL communication resources are allocated to a contention-free access procedure.

In S220, the received information is processed, wherein on the basis of the processing, a random access procedure to the cell is started by using the UL communication resources indicated in the received information.

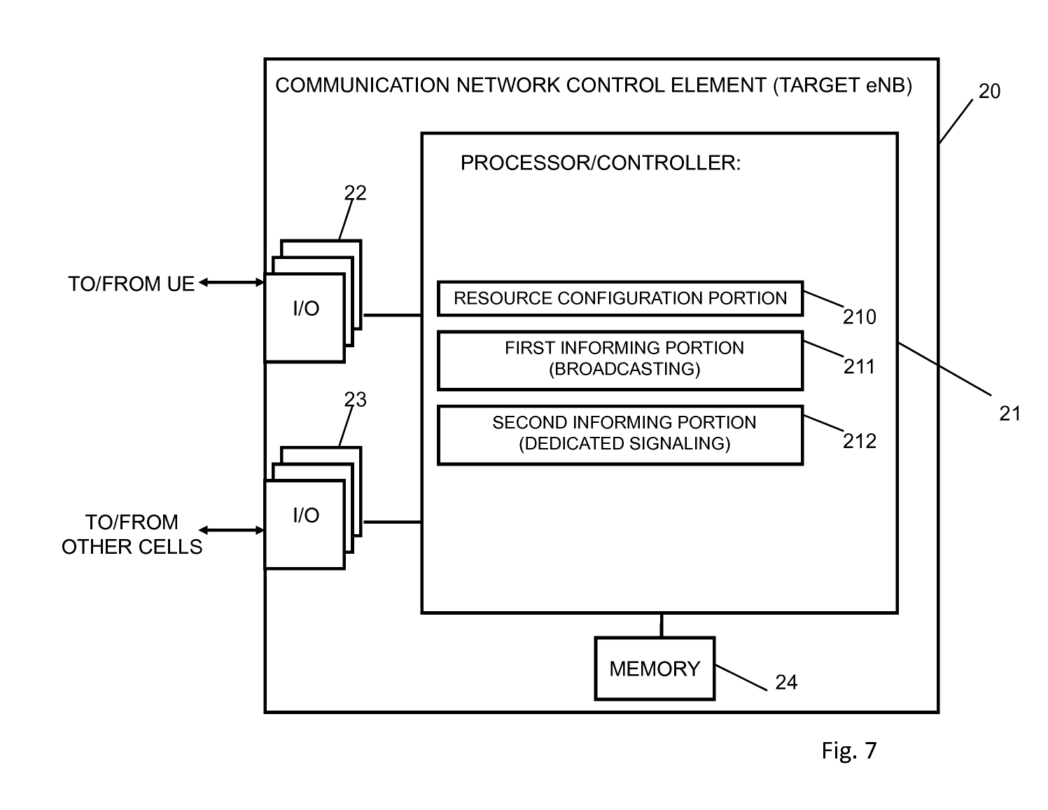

In FIG. 7, a diagram illustrating a configuration of a communication network control element, such as of the eNB B 20, is shown, which is configured to implement the resource provision and communication control procedure as described in connection with some of the examples of embodiments. It is to be noted that the communication network control element like the eNB B 20 shown in FIG. 7 may comprise further elements or functions besides those described herein below. Furthermore, even though reference is made to an eNB, the communication network control element may be also another device having a similar function, such as a chipset, a chip, a module etc., which can also be part of a communication network control element or attached as a separate element to a communication network control element, or the like. It should be understood that each block and any combination thereof may be implemented by various means or their combinations, such as hardware, software, firmware, one or more processors and/or circuitry.

The communication network control element shown in FIG. 7 may comprise a processing function, control unit or processor 21, such as a CPU or the like, which is suitable for executing instructions given by programs or the like related to the resource provision and communication control procedure. The processor 21 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference signs 22 and 23 denote transceiver or input/output (I/O) units (interfaces) connected to the processor 21. The I/O units 22 may be used for communicating with one or more communication elements like UEs. The I/O units 23 may be used for communicating with one or more network elements, like neighboring eNBs, and the core network. The I/O units 22 and 23 may be a combined unit comprising communication equipment towards several network elements, or may comprise a distributed structure with a plurality of different interfaces for different network elements. Reference sign 24 denotes a memory usable, for example, for storing data and programs to be executed by the processor 21 and/or as a working storage of the processor 21.

The processor 21 is configured to execute processing related to the above described handover procedure. In particular, the processor 21 comprises a sub-portion 210 as a processing portion which is usable for configuring resources. The portion 210 may be configured to perform processing according to S100 and S110 of FIG. 5. Furthermore, the processor 21 comprises a sub-portion 211 usable as a first portion for informing about resources. The portion 211 may be configured to perform processing according to S120 of FIG. 5. Furthermore, the processor 21 comprises a sub-portion 212 usable as a second portion for informing about resources. The portion 212 may be configured to perform a processing according to S130 of FIG. 5.

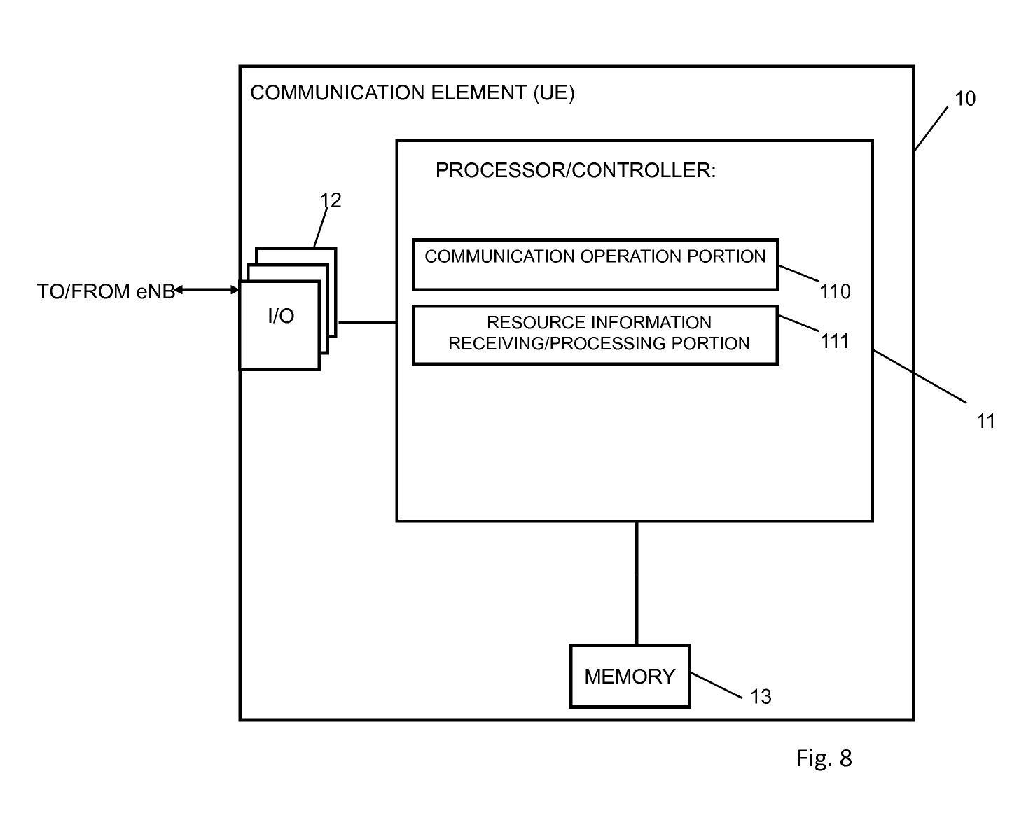

In FIG. 8, a diagram illustrating a configuration of a communication element, such as of UE 10, is shown, which is configured to implement the resource provision and communication control procedure as described in connection with some of the examples of embodiments. It is to be noted that the communication element like the UE 10 shown in FIG. 8 may comprise further elements or functions besides those described herein below. Furthermore, even though reference is made to an UE, the communication element may be also another device having a similar function, such as a chipset, a chip, a module etc., which can also be part of a communication element or attached as a separate element to a communication element, or the like. It should be understood that each block and any combination thereof may be implemented by various means or their combinations, such as hardware, software, firmware, one or more processors and/or circuitry.

The communication network control element shown in FIG. 8 may comprise a processing function, control unit or processor 11, such as a CPU or the like, which are suitable for executing instructions given by programs or the like related to the handover procedure. The processor 11 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference sign 12 denotes transceiver or input/output (I/O) units (interfaces) connected to the processor 11. The I/O units 12 may be used for communicating with one or more communication network control elements like eNBs. The I/O unit 12 may be a combined unit comprising communication equipment towards several network elements, or may comprise a distributed structure with a plurality of different interfaces for different network elements. Reference sign 13 denotes a memory usable, for example, for storing data and programs to be executed by the processor 11 and/or as a working storage of the processor 11.

The processor 11 is configured to execute processing related to the above described resource provision and communication control procedure. In particular, the processor 11 comprises a sub-portion 110 as a processing portion which is usable for executing a communication operation. The portion 110 may be configured to perform processing according to S200 of FIG. 6. Furthermore, the processor 11 comprises a sub-portion 111 usable as a portion for receiving and processing resource information. The portion 111 may be configured to perform processing according to S210 and S220 of FIG. 6.

As described above, according to some examples of embodiments, a set of communication resources may comprise one dedicated preamble for a random access channel (SPRACH preamble) and one temporary identifier in a cell radio network (C-RNTI) being associated to the dedicated preamble of the random access channel. However, according to some further examples of embodiments, the set of communication resources may comprise further parameters besides the C-RNTI and SPRACH preamble, for example target eNB security algorithm identifiers for selected security algorithms or the like.

Even though it is described above that a handover is to be executed from the small eNB A 30 to the macro eNB B 20, it is of course also possible that the direction is inverse. Also a handover with the eNB C 40 as the target cell, for example, is conducted according to the principles described above.

Moreover, the involved communication network control element is not restricted to an eNB, that is the target cell or source cell according to some examples of embodiments of the invention may be controlled by another network node type, e.g. a BS or the like.

In addition, according to some examples of embodiments, with regard to a process executed in a communication element or user device (e.g. UE 10 or UE 15), when the communication element (UE) has used resources provided by dedicated signalling from a communication network control element, e.g. from the eNB B 20, for example for conducting a handover or a contention-free random access procedure to the target cell (e.g. cell 200 of eNB B 20), i.e. after having used the SPRACH resources signalled via the dedicated signalling, the communication element (UE) is required to use a “normal” RACH resource. That is, for example, the communication element has to listen to broadcasting signalling for deriving a new resource information, e.g. to SIB2 for determining the broadcasted RACH resources, before making a new RACH attempt in the target cell. For this purpose, for example, processing portions or functions, e.g. provided by means of hardware or software, are provided in the respective communication element or used device which controls this processing. For example, a timer or counter function is also provided in the communication element and/or in the communication network control element which is used to determine that at least one RACH attempt using a resource being different to the SPRACH resources is made, or that a predetermined time has elapsed since the last access attempt using the SPRACH resources. For example, according to some examples of embodiments of the invention, in case a further UL communication resource for contention-free access is requested by a UE having already requested such a resource, the eNB may reject the request.

According to a further example of embodiments, there is provided an apparatus comprising resource configuration means configured to conduct a configuration of a first set of uplink communication resources for a random access procedure, and to conduct a configuration of a second set of uplink communication resources for a random access procedure, wherein the second set of uplink communication resources is different to the first set of uplink communication resources, first informing means configured to cause a transmission of information indicating communication resources of the first set of uplink communication resources by using a broadcasting signaling in a communication cell, and second informing means configured to cause a transmission of information indicating communication resources of the second set of uplink communication resources by using a dedicated signaling towards at least one dedicated recipient, the dedicated signaling being different to the broadcasting signaling.

In addition, the apparatus according to this example of embodiments may comprise additional means for carrying out a processing as described in connection with a communication network control element acting as a target eNB, for example, as described in connection with FIGS. 2 to 5, wherein such means may comprise at least one of the following means:
the resource configuration function may be further configured to conduct the configuration of the first set of uplink communication resources for the random access procedure by reserving uplink communication resources with a first periodicity, and to conduct the configuration of the second set of uplink communication resources for the random access procedure by reserving uplink communication resources with a second periodicity, wherein the second periodicity is equal to or greater than the first periodicity;
the resource configuration means may be further configured to conduct the configuration of the first set of uplink communication resources for the random access procedure by reserving uplink communication resources in a first subframe and to conduct the configuration of the second set of uplink communication resources for the random access procedure by reserving uplink communication resources in a second subframe, wherein the second subframe is provided with a predetermined time offset compared to the first subframe;
the resource configuration means may be further configured to conduct the configuration of the first set of uplink communication resources for the random access procedure by reserving uplink communication resources, wherein the uplink communication resources reserved for the first set of uplink communication resources are divided in a first subset allocated to a contention-free access procedure and a second subset allocated to a contention-based access procedure, and to conduct the configuration of the second set of uplink communication resources for the random access procedure by reserving uplink communication resources, wherein the uplink communication resources reserved for the second set of uplink communication resources are allocated to a contention-free access procedure;
the first informing means may be further configured to cause the transmission of information indicating communication resources of the first set of uplink communication resources by using a system information block broadcasted in the communication cell;
the second informing means may be further configured to cause the transmission of information indicating communication resources of the second set of uplink communication resources by using a dedicated signaling towards at least one communication network control element of a neighboring cell with regard to a handover procedure for a communication element from the neighboring cell;
the second informing means may be further configured to cause the transmission of information indicating communication resources of the second set of uplink communication resources by using a dedicated signaling towards the at least one communication network control element of the neighboring cell in reaction to a handover request for a communication element from the neighboring cell, wherein the handover request is received from the neighboring cell and indicates the requirement to provide information regarding uplink communication resources to be used for an access request by the communication element;
the second informing means may be further configured to cause the transmission of information indicating communication resources of the second set of uplink communication resources by using a dedicated signaling towards the at least one communication network control element of the neighboring cell in connection with a transmission of information indicating, to the neighboring cell, a content of a pool of communication resources for a fast handover procedure, wherein at least one communication resource of the second set of uplink communication resources is allocated to the pool of communication resources;
the second informing means may be further configured to cause the transmission of information indicating communication resources of the second set of uplink communication resources by using a dedicated signaling towards at least one communication element of the own cell with regard to an operation requiring a contention-free access procedure of the communication element;
the apparatus may be comprised in a communication network control element controlling a cell of a communication network in which a communication element can communicate, wherein the communication element is a terminal device or user equipment executing either a handover procedure to the communication network control element being a target for the handover of the communication element or a communication operation requiring a contention-free access procedure.

Furthermore, according to a further example of embodiments, there is provided an apparatus comprising communication operation means configured conduct an operation requiring a contention free access procedure to a cell to which a connection is established, and resource information receiving and processing means configured to receive, via a dedicated signaling, and process information indicating uplink communication resources of a second set of uplink communication resources for a random access procedure, the dedicated signaling being different to the broadcasting signaling, wherein the communication operation means are further configured to cause a random access procedure to the cell by using the uplink communication resources indicated in the received information.

In addition, the apparatus according to this example of embodiments may comprise additional means for carrying out a processing as described in connection with a communication element of the own cell, for example, as described in connection with FIG. 1, wherein such means may comprise at least one of the following means:
the resource information receiving and processing means may be further configured to receive, via a broadcasting signaling, and process information indicating uplink communication resources of a first set of uplink communication resources for a random access procedure;
the resource information receiving and processing means may be further configured to receive the information indicating uplink communication resources of a first set of uplink communication resources in the form of a system information block broadcasted in the communication cell;
the communication operation means may be configured to request provisioning of information indicating uplink communication resources usable for a contention-free access procedure;
the communication operation means may be configured to execute a timing advance update procedure as the operation requiring a contention free access procedure to the cell;
the apparatus may be comprised in a communication element communicating with a communication network control element controlling the cell of a communication network in which a communication element can communicate and to which the communication element is connected, wherein the communication element is a terminal device or user equipment.

It should be appreciated that
an access technology via which signaling is transferred to and from a network element may be any suitable present or future technology, such as WLAN (Wireless Local Access Network), WiMAX (Worldwide Interoperability for Microwave Access), LTE, LTE-A, Bluetooth, Infrared, and the like may be used; Additionally, embodiments may also apply wired technologies, e.g. IP based access technologies like cable networks or fixed lines. —a user device (also called UE, user equipment, user terminal, terminal device, etc.) illustrates one type of an apparatus to which resources on the air interface may be allocated and assigned, and thus any feature described herein with a user device may be implemented with a corresponding apparatus, such as a relay node. An example of such a relay node is a layer 3 relay (self-backhauling relay) towards the base station or eNB. The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. It should be appreciated that a device may be regarded as an apparatus or as an assembly of more than one apparatus, whether functionally in cooperation with each other or functionally independently of each other but in a same device housing.
embodiments suitable to be implemented as software code or portions of it and being run using a processor are software code independent and can be specified using any known or future developed programming language, such as a high-level programming language, such as objective-C, C, C++, C#, Java, etc., or a low-level programming language, such as a machine language, or an assembler,—implementation of embodiments, is hardware independent and may be implemented using any known or future developed hardware technology or any hybrids of these, such as a microprocessor or CPU (Central Processing Unit), MOS (Metal Oxide Semiconductor), CMOS (Complementary MOS), BiMOS (Bipolar MOS), BiCMOS (Bipolar CMOS), ECL (Emitter Coupled Logic), and/or TTL (Transistor-Transistor Logic).—embodiments may be implemented as individual devices, apparatuses, units or means or in a distributed fashion, for example, one or more processors may be used or shared in the processing, or one or more processing sections or processing portions may be used and shared in the processing, wherein one physical processor or more than one physical processor may be used for implementing one or more processing portions dedicated to specific processing as described,
an apparatus may be implemented by a semiconductor chip, a chipset, or a (hardware) module comprising such chip or chipset;—embodiments may also be implemented as any combination of hardware and software, such as ASIC (Application Specific IC (Integrated Circuit)) components, FPGA (Field-programmable Gate Arrays) or CPLD (Complex Programmable Logic Device) components or DSP (Digital Signal Processor) components.
embodiments may also be implemented as computer program products, comprising a computer usable medium having a computer readable program code embodied therein, the computer readable program code adapted to execute a process as described in embodiments, wherein the computer usable medium may be a non-transitory medium.

Although the present invention has been described herein before with reference to particular embodiments thereof, the present invention is not limited thereto and various modifications can be made thereto.

1. An apparatus comprising
at least one processor,
and
at least one memory for storing instructions to be executed by the processor, wherein
the at least one memory and the instructions are configured to, with the at least one processor, cause the apparatus at least:
to conduct a configuration of a first set of uplink communication resources for a random access procedure, and to conduct a configuration of a second set of uplink communication resources for a random access procedure, wherein the second set of uplink communication resources is different to the first set of uplink communication resources,
to cause a transmission of information indicating communication resources of the first set of uplink communication resources by using a broadcasting signaling in a communication cell, and
to cause a transmission of information indicating communication resources of the second set of uplink communication resources by using a dedicated signaling towards at least one dedicated recipient, the dedicated signaling being different to the broadcasting signaling.

2. The apparatus according to claim 1, wherein the at least one memory and the instructions are further configured to, with the at least one processor, cause the apparatus to conduct the configuration of the first set of uplink communication resources for the random access procedure by reserving uplink communication resources with a first periodicity, and to conduct the configuration of the second set of uplink communication resources for the random access procedure by reserving uplink communication resources with a second periodicity, wherein the second periodicity is equal to or greater than the first periodicity.

3. The apparatus according to claim 1, wherein the at least one memory and the instructions are further configured to, with the at least one processor, cause the apparatus to conduct the configuration of the first set of uplink communication resources for the random access procedure by reserving uplink communication resources in a first subframe and to conduct the configuration of the second set of uplink communication resources for the random access procedure by reserving uplink communication resources in a second subframe, wherein the second subframe is provided with a predetermined time offset compared to the first subframe.

4. The apparatus according to claim 1, wherein the at least one memory and the instructions are further configured to, with the at least one processor, cause the apparatus to conduct the configuration of the first set of uplink communication resources for the random access procedure by reserving uplink communication resources, wherein the uplink communication resources reserved for the first set of uplink communication resources are divided in a first subset allocated to a contention-free access procedure and a second subset allocated to a contention-based access procedure, and to conduct the configuration of the second set of uplink communication resources for the random access procedure by reserving uplink communication resources, wherein the uplink communication resources reserved for the second set of uplink communication resources are allocated to a contention-free access procedure.

5. The apparatus according to claim 1, wherein the at least one memory and the instructions are further configured to, with the at least one processor, cause the apparatus to cause the transmission of information indicating communication resources of the first set of uplink communication resources by using a system information block broadcasted in the communication cell.

6. The apparatus according to claim 1, wherein the at least one memory and the instructions are further configured to, with the at least one processor, cause the apparatus to cause the transmission of information indicating communication resources of the second set of uplink communication resources by using a dedicated signaling towards at least one communication network control element of a neighboring cell with regard to a handover procedure for a communication element from the neighboring cell.

7. The apparatus according to claim 6, wherein the at least one memory and the instructions are further configured to, with the at least one processor, cause the apparatus to cause the transmission of information indicating communication resources of the second set of uplink communication resources by using a dedicated signaling towards the at least one communication network control element of the neighboring cell in reaction to a handover request for a communication element from the neighboring cell, wherein the handover request is received from the neighboring cell and indicates the requirement to provide information regarding uplink communication resources to be used for an access request by the communication element.

8. The apparatus according to claim 6, wherein the at least one memory and the instructions are further configured to, with the at least one processor, cause the apparatus to cause the transmission of information indicating communication resources of the second set of uplink communication resources by using a dedicated signaling towards the at least one communication network control element of the neighboring cell in connection with a transmission of information indicating, to the neighboring cell, a content of a pool of communication resources for a fast handover procedure, wherein at least one communication resource of the second set of uplink communication resources is allocated to the pool of communication resources.

9. The apparatus according to claim 1, wherein the at least one memory and the instructions are further configured to, with the at least one processor, cause the apparatus to cause the transmission of information indicating communication resources of the second set of uplink communication resources by using a dedicated signaling towards at least one communication element of the own cell with regard to an operation requiring a contention-free access procedure of the communication element.

10. The apparatus according to claim 1, wherein the apparatus is comprised in a communication network control element controlling a cell of a communication network in which a communication element can communicate, wherein the communication element is a terminal device or user equipment executing either a handover procedure to the communication network control element being a target for the handover of the communication element or a communication operation requiring a contention-free access procedure.

11-20. (canceled)

21. An apparatus comprising
at least one processor,
and
at least one memory for storing instructions to be executed by the processor, wherein
the at least one memory and the instructions are configured to, with the at least one processor, cause the apparatus at least:
to conduct an operation requiring a contention free access procedure to a cell to which a connection is established,
to receive, via a dedicated signaling, and process information indicating uplink communication resources of a second set of uplink communication resources for a random access procedure, the dedicated signaling being different to the broadcasting signaling, and
to cause a random access procedure to the cell by using the uplink communication resources indicated in the received information.

22. The apparatus according to claim 21, wherein the at least one memory and the instructions are further configured to, with the at least one processor, cause the apparatus to receive, via a broadcasting signaling, and process information indicating uplink communication resources of a first set of uplink communication resources for a random access procedure.

23. The apparatus according to claim 22, wherein the uplink communication resources of the first set of uplink communication resources have a first periodicity and the uplink communication resources of the second set of uplink communication resources have a second periodicity, wherein the second periodicity is equal to or greater than the first periodicity.

24. The apparatus according to claim 22, wherein the uplink communication resources of the first set of uplink communication resources are located in a first subframe and the uplink communication resources of the second set of uplink communication resources are located in a second subframe, wherein the second subframe is provided with a predetermined time offset compared to the first subframe.

25. The apparatus according to claim 22, wherein the uplink communication resources of the first set of uplink communication resources are divided in a first subset allocated to a contention-free access procedure and a second subset allocated to a contention-based access procedure, and the uplink communication resources of the second set of uplink communication resources are allocated to a contention-free access procedure.

26. The apparatus according to claim 22, wherein the at least one memory and the instructions are further configured to, with the at least one processor, cause the apparatus to receive the information indicating uplink communication resources of the first set of uplink communication resources in the form of a system information block broadcasted in the communication cell.

27. The apparatus according to claim 21, wherein the at least one memory and the instructions are further configured to, with the at least one processor, cause the apparatus to request provisioning of information indicating uplink communication resources usable for a contention-free access procedure.

28. The apparatus according to claim 21, wherein the at least one memory and the instructions are further configured to, with the at least one processor, cause the apparatus to execute a timing advance update procedure as the operation requiring a contention free access procedure to the cell.

29. The apparatus according to claim 21, wherein the at least one memory and the instructions are further configured to, with the at least one processor, derive, after having caused a random access procedure to the cell by using the uplink communication resources indicated in the received information, uplink communication resources for a further attempt to conduct a random access procedure from information indicating uplink communication resources of a first set of uplink communication resources for a random access procedure received via a broadcasting signaling.

30. The apparatus according to claim 21, wherein the apparatus is comprised in a communication element communicating with a communication network control element controlling the cell of a communication network in which a communication element can communicate and to which the communication element is connected, wherein the communication element is a terminal device or user equipment.

31-45. (canceled)
